(19) United States
(12) Patent Application Publication
(10) Pub. No.: US 2007/0224961 A1
(43) Pub. Date: Sep. 27, 2007

(54) Receiver circuit

(75) Inventor: Jun Suzuki, Kumagaya-shi (JP)

Correspondence Address: OLIFF & BERRIDGE, PLC, P.O. BOX 19928, ALEXANDRIA, VA, 22320, US

(73) Assignee: SANYO ELECTRIC CO., LTD., MORIGUCHI-SHI (JP)

(21) Appl. No.: 11/712,952

(22) Filed: Mar. 2, 2007

(30) Foreign Application Priority Data
Mar. 10, 2006 (JP) 2006-065925

(51) Int. Cl. H04B 7/00

(52) U.S. Cl. 455/260

(57) ABSTRACT

In double-conversion receiver circuits, higher harmonics of a first local oscillating signal S_{LO1} and higher harmonics of a second local oscillating signal S_{LO2} enter a mixing circuit that converts a first intermediate frequency IF1 into a second intermediate frequency IF2, resulting in problems in that frequency IF2 signal components that are generated by the mixture of the two signals cause decreased sensitivity. As a countermeasure, an LPF 78 is provided between a second mixer circuit 60 and a divide-by-two frequency divider circuit 76 that supplies the signal S_{LO2} to the second mixer circuit 60. The LPF 78 removes the higher harmonic components of the signal S_{LO2} that may be generated in the divide-by-two frequency divider circuit 76. Even when higher harmonic components of the signal S_{LO1} that may be generated in a divide-by-n frequency divider circuit 72 enter the second mixer circuit 60 through the semiconductor substrate and the like, the higher harmonic components of the second local oscillating signal S_{LO2} are not mixed in, and the occurrence of signal components of the frequency IF2 that result from higher harmonics being mixed in can thereby be prevented.

### CROSS-REFERENCE TO RELATED APPLICATION

The priority application number JP2006-065925 upon which this patent application is based is hereby incorporated by the reference.

### FIELD OF THE INVENTION

The present invention relates to a double-conversion receiver circuit that receives wireless transmission signals, and particularly relates to improved sensitivity.

### DESCRIPTION OF THE PRIOR ART

Double-conversion circuit configurations for improving frequency selectivity in receivers for AM radio broadcasts and the like are well-known. FIG. 1 is a block diagram that shows the circuit configuration of a conventional double-conversion AM radio receiver. The main components of the receiver circuit are configured within an integrated circuit (IC) 2. A first mixer circuit 4 mixes a first local oscillating signal S_{LO1}, which is output from a first local oscillator 6, and an RF (radio frequency) signal S_{RF} that is obtained from an antenna 8, converting the frequency of the target receiver signal into a first intermediate frequency signal S_{IF1} having a prescribed intermediate frequency IF1. A second mixer circuit 10 mixes the signal S_{IF1} and a second local oscillating signal S_{LO2}, which is output from a second local oscillator 12, converting the frequency of the signal S_{IF1} into a second intermediate frequency signal S_{IF2} having a prescribed intermediate frequency IF2. After the signal S_{IF2} has been amplified, the amplitude modulation signal is detected, extracted, and output to an output circuit that is composed of a speaker or the like.

The first local oscillator 6 is configured to include a frequency divider circuit 22 and a first oscillator circuit 20 that is configured using a PLL (phase-locked loop). The first oscillator circuit 20 changes the frequency f_{OSC1} of an output oscillating signal S_{OSC1} in accordance with a target receiver frequency f_{R}. The frequency divider circuit 22 divides the signal S_{OSC1} and generates the signal S_{LO1} having the frequency (f_{R}+IF1). The first mixer circuit 4 then mixes the signal S_{LO1} and the signal S_{RF}, converting the received signal having the frequency f_{R} into the signal S_{IF1}, as described above.

The second local oscillator 12 is configured to include a frequency divider circuit 26 and a second oscillator circuit 24. The second oscillator circuit 24 outputs an oscillating signal S_{OSC2} having a frequency f₀ in accordance with an original oscillating signal S₀ having the frequency f₀ input from a crystal oscillator 28 that is attached outside the IC 2. The frequency divider circuit 26 divides the signal S_{OSC2} and outputs the signal S_{LO2} having the frequency (IF1−IF2). The second mixer circuit 10 then mixes the signal S_{LO2} into the signal S_{IF1}, converting the signal S_{IF1} into the signal S_{IF2} having the frequency IF2, as described above.

The double conversion system is flexible and easily made compatible with the broadcast frequencies of any country. Specifically, the frequency division ratio of the provided frequency divider circuit 22 is changed, whereby compatibility with any country is possible without changing the other blocks of the receiver circuit. If a programmable frequency divider circuit that allows the frequency division ratio to be set from the outside is used as the frequency divider circuit, this compatibility is possible merely by changing the setting.

The PLL used in the first oscillator circuit 20 may be configured to operate using the oscillating signal of the crystal oscillator 28 as a reference signal. The oscillation frequency f₀ of the crystal oscillator 28 is set higher than the frequency IF2 in order to improve the tracking speed of the PLL in this configuration. The frequency divider circuit 26 is provided in such instances to generate the second local oscillating signal S_{LO2} having the frequency (IF1−IF2) from the output signal S_{OSC2} having the frequency f₀ of the second oscillator circuit 24.

The frequency divider circuits 22, 26 may generate higher harmonic components outside the target frequency. Higher harmonic signals generated by the frequency divider circuit 22 and higher frequency signals output from the first oscillator circuit 20 induce fluctuations in the electrical potential of the electricity source or the ground level of the printed substrate or, when the receiver circuit is configured as an IC, in the semiconductor substrate. These signals may be superimposed on the signal S_{IF1} from the first mixer circuit 4 to the second mixer circuit 10 through such pathways that are outside the original signal wire. Higher harmonic components generated by the frequency divider circuit 26 may be superimposed on the second local oscillating signal S_{LO2} from the frequency divider circuit 26 to the second mixer circuit 10. The higher harmonic components superimposed on the signals S_{IF1}, S_{LO2} are mixed together in the second mixer circuit 10. As a result, a component of frequency IF2 is sometimes generated.

For example, when IF1=10.7 MHz, IF2=450 kHz, f₀=20.5 MHz, and the frequency division ratio of the frequency divider circuit 26 is 2, it is possible that the second local oscillating signal S_{LO2} will theoretically be generated having a frequency of (IF1−IF2); i.e., 10.25 MHz. When the target receiver frequency f_{R} is, e.g., 1500 kHz, the frequency (f_{R}+IF1) of the signal S_{LO1} is 12.2 MHz. The frequencies of the higher harmonic components mixed into the signals S_{LO1}, S_{LO2} will be designated as f_{HC1}, f_{HC2}, respectively. The combination of f_{HC1}=12.2 MHz×16=195.2 MHz and f_{HC2}=10.25 MHz×19=194.75 MHz yields f_{HC1}−f_{HC2}=IF2.

When the frequency f_{R} is 1510 kHz, f_{R}+IF1=12.21 MHz. The combination of f_{HC1}=12.21 MHz×5=61.05 MHz and f_{HC2}=10.25 MHz×6=61.5 MHz yields f_{HC1}−f_{HC2}=−IF2.

When the frequency f_{R} is 1690 kHz, f_{R}+IF1=12.39 MHz. The combination of f_{HC1}=12.39 MHz×5=61.95 MHz and f_{HC2}=10.25 MHz×6=61.5 MHz yields f_{HC1}−f_{HC2}=IF2.

As for other cases, if the frequency division ratio of the frequency divider circuit 22 is configured to be 8 and the frequency f_{R} is 850 kHz, the frequency of the output signal S_{OSC1} of the first oscillator circuit 20 is 92.4 MHz. The combination of f_{HC1}=92.4 MHz×3=277.2 MHz and f_{HC2}=10.25 MHz×27=276.75 MHz in this case yields f_{HC1}−f_{HC2}=IF2.

When components of the frequency IF2 resulting from higher harmonic components are mixed into the signal S_{IF2}, these components pass through a band-pass filter (BPF) 30, resulting in problems wherein beats or other noise are generated in the produced sound and the sensitivity of the receiver decreases.

### SUMMARY OF THE INVENTION

The present invention was devised in order to solve the aforementioned problems, it being an object thereof to minimize beats resulting from higher harmonic components that may be generated during the generation of the two local oscillating signals and to make improvements in the sensitivity of the receiver.

The receiver circuit according to the present invention is a double-conversion receiver circuit comprising a first local oscillator for generating a first local oscillating signal; a first mixer circuit for mixing the first local oscillating signal and a received signal having a radio frequency, and generating a first intermediate frequency signal; a second local oscillator for generating a second local oscillating signal; and a second mixer circuit for mixing the first intermediate frequency signal and the second local oscillating signal, and generating a second intermediate frequency signal. The first local oscillator has a first oscillator circuit for generating a first primary oscillating signal; and a first frequency divider circuit for dividing the first primary oscillating signal and generating the first local oscillating signal. The second local oscillator has a second oscillator circuit for generating a second primary oscillating signal; a second frequency divider circuit for dividing the second primary oscillating signal and generating the second local oscillating signal; and a frequency filter that is connected to an output terminal of the second frequency divider circuit and that minimizes passage to the second mixer circuit of a signal component that is at or above a prescribed cut-off frequency.

### BRIEF DESCRIPTION OF THE DRAWINGS

FIG. 1 is a block diagram that shows the circuit configuration of a conventional double-conversion AM-radio receiver; and

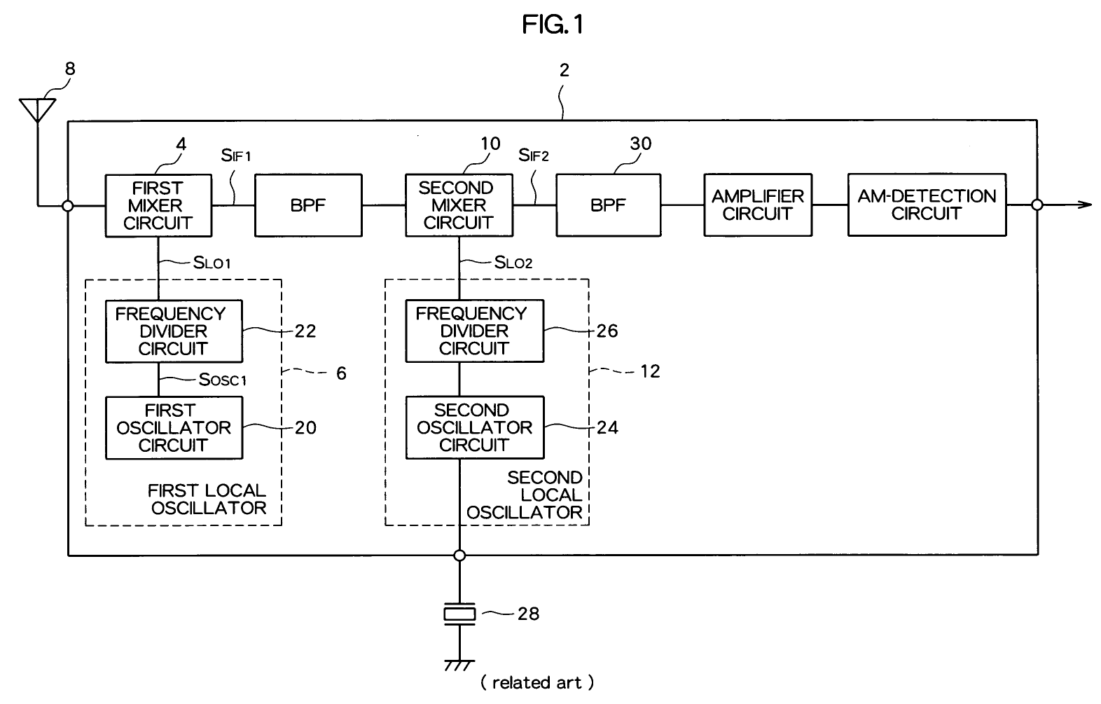

FIG. 2 is a block diagram that shows an abbreviated circuit configuration of a double-conversion AM-radio receiver that is an embodiment of the present invention.

### DESCRIPTION OF THE PREFERRED EMBODIMENTS

An embodiment of the present invention will be described below with reference to the drawings.

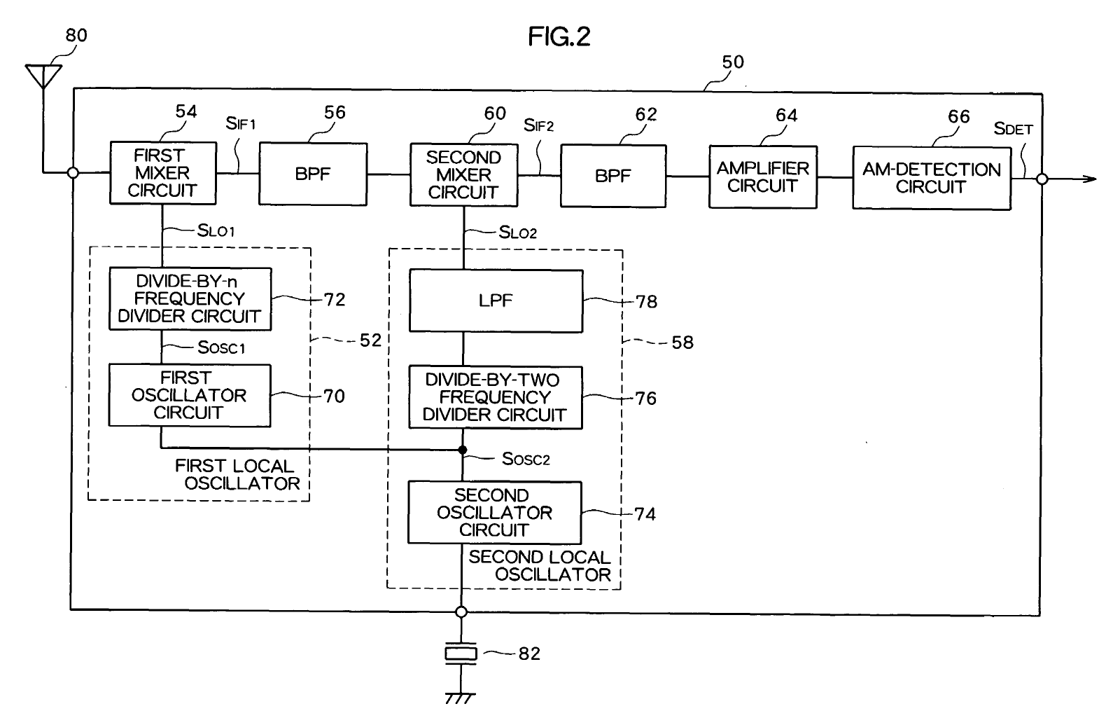

FIG. 2 is a block diagram that shows an abbreviated circuit configuration of a double-conversion AM-radio receiver that is an embodiment of the present invention. The main components of the receiver circuit are configured in an integrated circuit (IC) 50. A first local oscillator 52, a first mixer circuit 54, a BPF 56, a second local oscillator 58, a second mixer circuit 60, a BPF 62, an amplifier circuit 64, and an AM-detection circuit 66 are configured in the IC 50.

The first local oscillator 52 is configured to include a first oscillator circuit 70 and a divide-by-n frequency divider circuit 72. The second local oscillator 58 is configured to include a second oscillator circuit 74, a divide-by-two frequency divider circuit 76, and a low-pass filter (LPF) 78.

An RF signal S_{RF} from an antenna 80 and an original oscillating signal S₀ having a frequency f₀ from a crystal oscillator 82 are input to the IC 50. An AM-detection signal S_{DET} is output from the IC 50.

The first oscillator circuit 70 outputs an oscillating signal S_{OSC1} having a frequency f_{OSC1} and is configured using a PLL. The frequency f_{OSC1} is changed in accordance with a target receiver frequency f_{R} by adjusting a voltage-control signal to a voltage-controlled oscillator (VCO) that acts as the main configurational component of the PLL. The frequency f_{OSC1} is set to n·(f_{R}+IF1). In this case, “n” is the frequency division ratio of the divide-by-n frequency divider circuit 72. IF1 is the frequency of a first intermediate frequency signal S_{IF1} that is output from the first mixer circuit 54 and is set to, e.g., 10.7 MHz. An oscillating signal S_{OSC2} having a frequency f₀ output from the second oscillator circuit 74 is used as the reference signal of the PLL.

The signal S_{OSC1} that is output by the first oscillator circuit 70 is divided by n in the divide-by-n frequency divider circuit 72, which generates a first local oscillating signal S_{LO1} having a frequency (f_{R}+IF1) and outputs the signal S_{LO1} to the first mixer circuit 54.

The first mixer circuit 54 mixes the first local oscillating signal S_{LO1}, which was output from the divide-by-n frequency divider circuit 72, into the RF signal S_{RF} obtained from the antenna 80, converting the frequency of the target receiver signal, which has the frequency f_{R} and is included in the RF signal S_{RF}, into a first intermediate frequency signal S_{IF1} having the intermediate frequency IF1.

The BPF 56 has a pass band that corresponds to the frequency IF1 and extracts the signal S_{IF1} output from the first mixer circuit 54, outputting the signal S_{IF1} to the second mixer circuit 60.

The second oscillator circuit 74 outputs the oscillating signal S_{OSC2} having the frequency f₀ that corresponds to an original oscillating signal S₀ having the frequency f₀ input from the crystal oscillator 82. The frequency f₀ is set to 2(IF1−IF2). IF2 is the frequency of a second intermediate frequency signal S_{IF2} that is output from the second mixer circuit 60 and is set to, e.g., 450 kHz. The frequency f₀ is set to 20.5 MHz in accordance with the value of the frequency IF2 and the value of the frequency IF1, which was given above as 10.7 MHz. The oscillating signal S_{OSC2} is output to the divide-by-two frequency divider circuit 76. The oscillating signal S_{OSC2} is also used as the reference signal for the PLL of the first oscillator circuit 70, as described above.

The signal S_{OSC2} is divided by two in the divide-by-two frequency divider circuit 76, which generates a second local oscillating signal S_{LO2} having the frequency (IF1−IF2) and outputs the signal S_{LO2} to the LPF 78. When the frequencies IF1, IF2 are 10.7 MHz and 450 kHz, respectively, as described above, (IF1−IF2) is 10.25 MHz.

The cut-off frequency of the LPF 78 is set to remove or reduce higher harmonics in the signal S_{LO2} while passing the signal S_{LO2} at a frequency of (IF1−IF2). In other words, the signal S_{LO2} is selectively input to the second mixer circuit 60 by the LPF 78, and higher harmonics in the signal S_{LO2} are prevented from being input.

The second mixer circuit 60 mixes the second local oscillating signal S_{LO2}, which is output from the LPF 78, into the first intermediate frequency signal S_{IF1}, which is output from the BPF 56, converting the frequency of the signal S_{IF1} into a second intermediate frequency signal S_{IF2} having the intermediate frequency IF2.

The BPF 62 has a pass band that corresponds to the frequency IF2 and extracts the signal S_{IF2} output from the second mixer circuit 60, outputting the signal S_{IF2} to the amplifier circuit 64.

The amplifier circuit 64 amplifies the signal S_{IF2}, outputting the signal S_{IF2} to the AM-detection circuit 66.

The AM-detection circuit 66 detects an amplitude modulation signal in the signal S_{IF2} using envelope detection or another method, outputting the detected signal S_{DET} to an output circuit that is composed of a speaker or the like.

Higher harmonic components that may be generated in the divide-by-two frequency divider circuit 76 can be prevented from being transmitted to the second mixer circuit 60 in the present receiver circuit by providing the LPF 78. Specifically, input to the second mixer circuit 60 of one of the two signals that may generate beats when mixed together in the second mixer circuit 60 can be obstructed. The occurrence of beats can therefore be avoided even when the other of the two signals, i.e., the signal S_{OSC1} and the higher harmonics in the signal S_{OSC1} that are generated in the first oscillator circuit 70, or the higher harmonic components of the signal S_{OSC1} that may be generated in the divide-by-n frequency divider circuit 72, is conveyed within the semiconductor substrate and superimposed on the signal input to the second mixer circuit 60.

An example was described above in which the receiver circuit was configured as an IC, but the present invention can also be applied to a receiver circuit configured as a discrete circuit on a printed substrate or the like. Specifically, one of the two signals that cause beats can be blocked by providing the LPF 78, whereby the occurrence of beats can be avoided even when the other signal enters the second mixer circuit 60 through the ground lines and electricity-source lines that may connect the circuit blocks together.

The receiver circuit according to the present invention as described above is a double-conversion receiver circuit comprising a first local oscillator for generating a first local oscillating signal; a first mixer circuit for mixing the first local oscillating signal and a received signal having a radio frequency, and generating a first intermediate frequency signal; a second local oscillator for generating a second local oscillating signal; and a second mixer circuit for mixing the first intermediate frequency signal and the second local oscillating signal, and generating a second intermediate frequency signal. The first local oscillator has a first oscillator circuit for generating a first primary oscillating signal; and a first frequency divider circuit for dividing the first primary oscillating signal and generating the first local oscillating signal. The second local oscillator has a second oscillator circuit for generating a second primary oscillating signal; a second frequency divider circuit for dividing the second primary oscillating signal and generating the second local oscillating signal; and a frequency filter that is connected to an output terminal of the second frequency divider circuit and that minimizes passage to the second mixer circuit of a signal component that is at or above a prescribed cut-off frequency.

The first oscillator circuit may be configured to perform PLL control using as a reference a reference oscillating signal that is generated based on an original oscillating signal having a frequency that is higher than the second intermediate frequency signal, and to generate the first primary oscillating signal. The second oscillator circuit may also be configured so that the original oscillating signal is input and the second primary oscillating signal is generated having a frequency that corresponds to the original oscillating signal.

The frequency filter in the receiver circuit of the present invention may be configured as a low-pass filter for minimizing a higher harmonic component of the second local oscillating signal that is generated in the second frequency divider circuit.

The invention as described above is particularly effective when the receiver circuit is formed as an integrated circuit on a shared semiconductor substrate.

By using a frequency filter that is inserted between the second frequency divider circuit and the second mixer circuit on the transmission pathway of the second local oscillating signal, the receiver circuit of the present invention removes or reduces higher harmonic components that are superimposed on the second local oscillating signal, which is one of two signals that cause beats and the like when mixed together in the second mixer circuit. Higher harmonic components can thereby be stopped from being mixed in at the second mixer circuit, the occurrence of noise can be prevented, and the sensitivity of the receiver can be improved.

What is claimed is:

1. A double-conversion receiver circuit comprising:
a first local oscillator for generating a first local oscillating signal;
a first mixer circuit for mixing the first local oscillating signal and a received signal having a radio frequency, and generating a first intermediate frequency signal;
a second local oscillator for generating a second local oscillating signal; and
a second mixer circuit for mixing the first intermediate frequency signal and the second local oscillating signal, and generating a second intermediate frequency signal, wherein
the first local oscillator has:
a first oscillator circuit for generating a first primary oscillating signal; and
a first frequency divider circuit for dividing the first primary oscillating signal and generating the first local oscillating signal, and wherein
the second local oscillator has:
a second oscillator circuit for generating a second primary oscillating signal;
a second frequency divider circuit for dividing the second primary oscillating signal and generating the second local oscillating signal; and
a frequency filter that is connected to an output terminal of the second frequency divider circuit and that minimizes passage to the second mixer circuit of a signal component that is at or above a prescribed cut-off frequency.

2. The receiver circuit according to claim 1, wherein the frequency filter is a low-pass filter for minimizing a higher harmonic component of the second local oscillating signal that is generated in the second frequency divider circuit.

3. The receiver circuit according to claim 1, wherein the receiver circuit is an integrated circuit formed on a shared semiconductor substrate.

4. A double-conversion receiver circuit comprising:
a first local oscillator for generating a first local oscillating signal;
a first mixer circuit for mixing the first local oscillating signal and a received signal having a radio frequency, and generating a first intermediate frequency signal;
a second local oscillator for generating a second local oscillating signal; and
a second mixer circuit for mixing the first intermediate frequency signal and the second local oscillating signal, and generating a second intermediate frequency signal, wherein
the first local oscillator has:
a first oscillator circuit for performing PLL control using as a reference a reference oscillating signal that is generated based on an original oscillating signal having a frequency that is higher than the second intermediate frequency signal, and generating a first primary oscillating signal; and
a first frequency divider circuit for dividing the first primary oscillating signal and generating the first local oscillating signal, and wherein
the second local oscillator has:
a second oscillator circuit for generating a second primary oscillating signal having a frequency that corresponds to the original oscillating signal, which is input to the second oscillator circuit;
a second frequency divider circuit for dividing the second primary oscillating signal and generating the second local oscillating signal; and
a frequency filter that is connected to an output terminal of the second frequency divider circuit and that minimizes passage to the second mixer circuit of a signal component that is at or above a prescribed cut-off frequency.

5. The receiver circuit according to claim 4, wherein the frequency filter is a low-pass filter for minimizing a higher harmonic component of the second local oscillating signal that is generated in the second frequency divider circuit.

6. The receiver circuit according to claim 4, wherein the receiver circuit is an integrated circuit formed on a shared semiconductor substrate.

7. The receiver circuit according to claim 4, wherein the second primary oscillating signal is input from the second oscillator circuit to the first oscillator circuit as the reference oscillating signal.
